(19) United States
(12) Patent Application Publication
(10) Pub. No.: US 2009/0059363 A1
(43) Pub. Date: Mar. 5, 2009

(54) MICROSCOPE SYSTEM

(75) Inventors: Fritz Straehle, Heubach (DE); Christoph Hauger, Aalen (DE)

Correspondence Address: KNOBBE MARTENS OLSON & BEAR LLP, 2040 MAIN STREET, FOURTEENTH FLOOR, IRVINE, CA, 92614, US

(73) Assignee: CARL ZEISS SURGICAL GMBH, Oberkochen (DE)

(21) Appl. No.: 12/205,742

(22) Filed: Sep. 5, 2008

Related U.S. Application Data
(63) Continuation of application No. PCT/EP2007/002025, filed on Mar. 8, 2007.

(30) Foreign Application Priority Data
Mar. 8, 2006 (DE) 10 2006 010 767.5

(51) Int. Cl. G02B 21/06

(52) U.S. Cl. 359/389

(57) ABSTRACT

A microscope system for imaging an object which can be arranged in an object plane of the microscope system, which includes an imaging system, a displacement device and a controller is described. The imaging system may provide at least one optical imaging path for imaging an imaging field of the object plane. The displacement device may be adapted to translatory displace the imaging field of the imaging system in the object plane. The controller is adapted to determine a desired displacement of the imaging field in the object plane and to correspondingly control the displacement device.

### CROSS-REFERENCE TO RELATED APPLICATIONS

This application is a continuation of International Application No. PCT/EP2007/002025 filed on Mar. 8, 2007 which claims priority to German Application No. 10 2006 010 767.5 filed on Mar. 8, 2006.

### BACKGROUND OF THE INVENTION

1. Field of the Invention

The present invention relates to a microscope system for imaging an object that can be disposed in an object plane of the microscope system.

2. Description of the Related Art

The microscope system comprises at least one imaging system which provides at least one optical imaging path for imaging a finite (i.e. not punctiform) imaging field of the object plane as well as a displacement device which is adapted to translatory displace the imaging field of the imaging system in the object plane.

Such microscope systems are e.g. used in medical engineering as surgical microscopes in order to observe an object disposed in an object plane.

To this end, the surgical microscope is usually supported by a stand that is affixed to a ceiling or stands on the floor. The stand serves as a displacement device in order to allow a positioning of the surgical microscope above an observed object. For this purpose, the stand usually allows a translatory displacement of the imaging system with up to three degrees of freedom (forward/backward, left-hand/right-hand, upward/downward) and, mostly, a rotatory movement of the surgical microscope with at least one degree of freedom (pivoting with respect to the horizontal).

Such stands are relatively expensive since, on the one hand, they need to have a high stability and freedom from vibrations in the locked-in state and, at the same time, must be easily actuable. For this purpose, the stand must be of a sufficiently solid construction and the surgical microscope supported by the stand must be balanced out if possible, in any position of the surgical microscope by using springs or counter-weights. Furthermore, a positioning with great accuracy must be possible, since an imaging field (area of the object plane that is imaged by an imaging system of the surgical microscope) of the surgery microscope, is very small in particular in the case of a high magnification.

The aforementioned construction of a microscope system of the prior art that consists of a surgical microscope and a stand supporting the same has the following disadvantages:

Due to the large mass of the surgical microscope and the stand, it is only possible with difficulties to follow small movements of an observed object by displacing the surgical microscope or to carry out fine adjustments in the positioning of the surgical microscope as a result of the inert masses that are to be accelerated and/or decelerated even in the case of a stand that is balanced to the best possible extent.

Moreover, the actuation of a conventional stand is physically strenuous even in the case of an optimum balancing, if many small positionings must be carried out. This is also because, as a rule, a new positioning of the surgical microscope requires that the user directly or indirectly acts with his or her hands via a controller and thus must interrupt his or her work.

To solve these problems a surgical microscope system having a mechanical-motorized displacement device is known from DE 103 30 581 A1, which is inserted between the surgical microscope and the stand in order to be able to laterally displace the surgical microscope relative to the object plane by using a controllable drive without having to release the brakes in the joints of the stand and to change the orientation of the stand elements relative to each other.

This displacement device, however, has the disadvantage that it is technically complex and that, due to its dead weight, a comparatively more complex and more stable stand is required. Moreover, an acceleration of the inert mass of the surgical microscope is still required for a displacement of the surgical microscope. The inert mass of the surgical microscope, on the one hand, prevents a rapid displacement, and, on the other, there is the risk, in the case of a rapid positive or negative acceleration of the inert mass of the surgical microscope, that vibrations are generated and transmitted to the stand. Moreover, it is necessary in case of a direct visual observation after a displacement of the surgical microscope that the user at least slightly adapts his or her working position.

Due to the aforementioned disadvantages of the prior art, it is practically impossible at present to carry out small, rapid and in particular periodic displacements of the surgical microscope in order to react to the displacements of an observed object in the object place, which is e.g. caused by the breathing of a patient.

### SUMMARY OF THE INVENTION

Starting from this, it is an object of the present invention to provide a microscope system which renders a displacement of an imaging field of the object plane possible in an especially simple, fast, reliable and vibration-free fashion.

The above object is solved by a microscope system with the combination of the features of the independent claims 1 and 6. Preferred embodiments are defined in the dependent claims.

According to a first preferred embodiment, a microscope system for imaging an object that can be disposed in an object plane of the microscope system comprises an imaging system, a displacement device and a controller. The imaging system provides at least one optical imaging path for imaging an imaging field of the object plane. In this respect, the imaging field is understood to be the finite (i.e. not punctiform) area of the object plane which can be imaged by the at least one optical imaging path of the imaging system at a point in time. Frequently, the imaging field is also referred to as object field in the prior art. The displacement device is adapted to translatory displace the imaging field of the imaging system in the object plane. The controller is adapted to determine a desired displacement of the imaging field in the object plane and to accordingly control the displacement device. To this end, the displacement device comprises a first mirror surface disposed along the at least one optical imaging path to deflect the at last one optical imaging path, said first mirror surface being pivotable in dependence on (as a function of) the displacement determined by the controller.

Thus, in the first embodiment, a desired displacement of the imaging field of the object plane relative to the object plane, which is determined by the controller takes place by pivoting a first mirror surface deflecting the at least one optical imaging path of the imaging system. The term “mirror surface” as used in this document refers in general to the reflection surface of an optical deflection element.

The mirror surface may e.g. be pivotable freely or about one or several predefined different swivel axes. The swivel axes may optionally be outside of or within the mirror surface. The mirror surface and the swivel axes may also optionally be in the same or in different planes. According to an embodiment, two swivel axis that are orthogonal to each other are provided, which area intersect each other in an area of the mirror surface, at which an optical axis of an optical imaging path incident on the mirror surface impinges on the mirror surface. This area may be in the center of the mirror surface. The swivel axes are imaginary axes. This means that the mirror surface is rotated about these imaginary axes and does not mean that a shaft such as e.g. a rod must be installed.

Alternatively, the displacement of the imaging field may also be caused by rotating the mirror surface about an axis of rotation which is aligned substantially in parallel with an optical axis of the at least one optical imaging path of the imaging system, which impinges on the mirror surface, said optical axis being defined by optical elements (in particular optical lenses) of the imaging system. Within this application, it is understood by an axis of rotation which is oriented substantially in parallel with the optical axis, that the planes spanned in each case by the axis of rotation and/or the optical axis and a common normal intersect each other at an angle of less than 20°, preferably less than 5° and especially preferred less than 2°. Here, the axis of rotation and the optical axis may also coincide. In other words, the mirror surface may also be rotated about an axis of rotation which, together with a normal to the mirror surface, encloses an angle that differs from zero. Due to such a rotation of the mirror surface, a pivoting of the mirror surface relative to the optical axis of the at least one optical imaging path incident from the imaging system on the mirror surface is caused, which results in the displacement of the imaging field in the object plane.

A pivoting of a mirror surface is possible with great accuracy. Since only the inert mass of a deflection element providing the mirror surface (such as for instance, but not exclusively, an optical mirror or prism) as well as a possibly present drive and/or transmission, but not the inert mass of the entire imaging system, must be accelerated, small, fast and in particular periodic displacements of the imaging field are possible in an especially simple and reliable fashion. Here, the displacement device works in an almost vibration-free fashion even in the case of high accelerations due to the small inert mass to be accelerated.

Since only the mirror surface is pivoted for the desired displacement of the imaging field, and the imaging system remains, however, stationary, a working position of a user can be retained unchanged after the displacement of the imaging field even in the case of a direct visual observation.

In the case of a displacement which is e.g. less than one quarter and preferably less than one eighth of a working distance of the imaging system from the object plane, an almost vertical imaging of the object plane by using the imaging system further takes place. However, it is emphasized that a non-vertical viewing of the object plane through the imaging system is also not detrimental in most cases and may even be desired.

According to an embodiment, the displacement device may also comprise a second mirror surface for deflecting the at least one optical imaging path, said second mirror surface being disposed along the at least one optical imaging path and being pivotable in dependence on the displacement determined by the controller. The first mirror surface may then be pivotable about a first swivel axis and the second mirror surface may be pivotable about a second swivel axis, said second swivel axis being different from the first swivel axis.

Thus, the displacement of the imaging field may also be jointly caused by the pivoting of two or also more mirror surfaces which successively deflect the at least one optical imaging path. This may have advantages, since a pivoting of a mirror surface about a single predefined axis is often possible with more ease and with greater accuracy than a free pivoting of a mirror surface.

Here, the first swivel axis can enclose an angle of substantially 90° with a first deflection plane that is spanned by an optical axis of the at least one optical imaging path that impinges on the first mirror surface and exits from the first mirror surface. Here, the optical axis is defined by optical elements (in particular optical lenses) of the imaging system. Moreover, the second swivel axis can enclose an angle of substantially 90° with a second deflection plane which is spanned by the optical axis of the at least one optical imaging path, which impinges on the second mirror surface and exits from the second mirror surface, and, at the same time, may be arranged substantially in parallel to the first deflection plane.

In this application, “substantially 90°” is understood to be a deviation from 90° by 5° as a maximum and preferably by 2° as a maximum and especially preferred of 1° as a maximum. Moreover, in this application, it is understood by a swivel axis, which is substantially in parallel to a deflection plane, that the swivel axis is in parallel to the deflection plane or that the swivel axis intersects the deflection plane and encloses an angle of less than 5° and preferably less than 2° with the deflection plane. Moreover, the swivel axis and the deflection plane may alternatively also coincide.

According to an embodiment, the first and the second swivel axis extend in each case in an area, in which the optical axis incident on the respectively first and second mirror surface impinges on the respective mirror surface. This area can be located in the center of the respectively associated first and second mirror surfaces.

This relationship of the first and second swivel axis relative to the at least one optical imaging path and/or relative to each other has the advantage that a pivoting of the first and second mirror surfaces about the swivel axes, in addition to the displacement of the imaging field relative to the object plane, does not cause any rotation or only causes a negligible rotation of the image of the image field, which is generated by the imaging system. Moreover, a translation of the imaging field in the object plane in two directions which, together, also enclose an angle of substantially 90° is thus enabled.

Alternatively or additionally, the microscope system may also comprise a compensation device which causes a rotation of the image of the imaging field, which is generated by the imaging system. Here, the controller controls the compensation device in dependence on a pivoting of the first and/or the second mirror surface such that a rotation of the image of the imaging field, which is provided by the imaging system, said rotation being possibly caused by a pivoting of the mirror surfaces, is again compensated by a rotation of the image caused by the compensation device.

Here, the imaging system may comprise at least one camera arranged in the at least one optical imaging path for generating image data and the compensation device may be connected with the at least one camera. The compensation device can then cause a rotation of the image data generated by the at least one camera by using electronic image processing, in order to compensate for a rotation of the image of the imaging field provided by the imaging system, which is possibly caused by a pivoting of the mirror surfaces, in an especially simple fashion.

Alternatively and additionally, the compensation device may comprise at least one prism arrangement disposed in the at least optical imaging path and adjustable by the controller. Here, the prism arrangement is preferably adapted to cause, in the case of a rotation of the prism, a rotation of the image about the optical axis as the axis of rotation which optical axis is defined by the optical elements of the imaging system.

According to a second preferred embodiment, which can also be combined with the preceding first preferred embodiment, a microscope system for imaging an object which can be disposed in an object plane of the microscope system comprises an imaging system which provides at least one optical imaging path for the imaging of an imaging field of the object plane as well as a displacement device which is adapted to translatory displace the imaging field of the imaging system in the object plane. Here, the displacement device comprises at least one pair of first and second mirror surfaces for the deflection of the at least one optical imaging path, which are disposed along the at least one optical imaging path. Here, the at least one pair of optical imaging paths is successively reflected at the first and the second mirror surface. Moreover, the first mirror surface is pivotable about a first swivel axis, said first swivel axis enclosing an angle of substantially 90° with a first deflection plane which is spanned by an optical axis of the at least one optical imaging path which optical axis impinges on the first mirror surface and exits from the first mirror surface. Here, the optical axis is defined by optical elements (in particular optical lenses) of the imaging system. Moreover, the second mirror surface is pivotable about a second swivel axis, said second swivel axis enclosing an angle of substantially 90° with a second deflection plane which is spanned by the optical axis of the at least one optical imaging path which optical axis impinges on the second mirror surface and exits from the second mirror surface. Moreover, the second swivel axis is disposed substantially in parallel with the first deflection plane. Here, the second swivel axis may also be located in the first deflection plane.

A translatory displacement of the imaging field in the object plane in two directions, which, together, enclose an angle of substantially 90°, is thus enabled by pivoting the first and/or the second mirror surface about the first and/or second swivel axis. Here, said orientation of the first and second swivel axes relative to the at least one optical imaging path results in that a pivoting of the mirror surfaces does not cause any rotation and/or only causes a negligible rotation of the image of the imaging field, which is generated by the imaging system.

As in the first preferred embodiment, the microscope system can also comprise a controller which is adapted to determine a desired displacement of the imaging field in the object plane and to pivot the first and the second mirror surface about the respectively first and/or second swivel axis in dependence on the determined displacement.

In general, the imaging system may comprise at least one camera for generating image data, which is disposed in an optical imaging path, and the controller may be connected with the at least one camera and, moreover, be adapted to automatically detect the position of a marker in the image data and to automatically control the first and/or second drive in dependence on the detected position of the marker.

Here, the marker may e.g. be a separate element (e.g. a characteristically formed adhesive label) specifically disposed in the object plane, or it may also be a characteristic element of the object itself, which is automatically identified in the image data (such as e.g. a surgical element/instrument or a specific part of the body of a patient such as a tooth or an organ, which is imaged in the image data).

Here, it may be desirable if the controller is adapted to automatically control the first and/or second drive so that the position of the marker in the image data remains substantially constant.

As a result, an (also automatic) image stabilization or a (also automatic) tracking of the movement of an observed object is e.g. possible. The image stabilization is in particular desirable, if an observed object is subjected to periodic changes in position (e.g. due to the breathing of a patient). When tracking the movement of an object, it is e.g. possible to follow the movement of a surgical instrument and to always hold the surgical instrument in the center of the imaging field.

Moreover or alternatively, the controller may also comprise a user interface such as e.g. a keyboard, a pedal, a joystick, a voice control, etc. and may determine the desired displacement of the imaging field in the object plane in dependence on a control command received via the user interface.

An absolute displacement (e.g. in the form of target coordinates), a relative displacement (e.g. in the form of a displacement vector starting from the current center of the image) and/or only one direction of a displacement in connection with a period of time (e.g. the holding of a joystick in a desired direction until a desired displacement is achieved) can for example be input by a user via the user interface.

Here, the user interface can be further adapted to receive control commands by a user in the form of voice and/or a movement of an eye and/or a movement of a foot and/or a movement of the head and/or a movement of a hand of the user and to output them (in digital or analog form) to the controller.

In general, the imaging system may comprise a plurality of optical lenses. According to an embodiment, at least one optical lens of the imaging system is then arranged between the first and the second mirror surface.

In order to obtain a construction of the microscope system that is as compact as possible by using a multiple folding of the at least one optical imaging path, the imaging system may furthermore comprise a third mirror surface and a fourth mirror surface to deflect the at least one optical imaging path. The at least one optical imaging path can then be successively reflected at the first mirror surface, the second mirror surface, the third mirror surface and the fourth mirror surface.

Here, it can be advantageous if the first mirror surface and the fourth mirror surface enclose relative to each other an angle of from 60° to 120° and preferably from 80° to 100° and the second mirror surface and the third mirror surface enclose relative to each other an angle of from 60° to 120° and preferably of from 80° to 100°. Moreover, the third mirror surface and the fourth mirror surface may enclose relative to each other an angle of substantially 90°. The reason is that, all in all, mirror surfaces disposed at this angle act as a Porro system of the second type. Consequently, the lateral reversals of the image, which are caused at the mirror surfaces, neutralize each other due to the deflections of the at least one optical imaging path. Moreover, an image rotation altogether caused by the deflections of the optical imaging paths is small and/or not present.

According to an embodiment, in such an arrangement of the first to fourth mirror surfaces, the at least one optical imaging path is guided in such a way that the optical axes of the at least one optical imaging path extend in at least a first and a second plane which are substantially in parallel with each other and extend in at least a third plane which is substantially vertical to the two first and second planes. Here, the condition of “substantially in parallel” and “substantially vertical” is deemed as fulfilled, if the third plane intersects the two first and second planes in each case at an angle of from 60° to 120° and preferably from 80 to 100° and especially preferred from 85° to 95° and especially 90°. In the present case, the first plane is spanned by optical axes of the imaging beam bundles of the at least one optical imaging path which impinge on the first mirror surface and exit from the same, the second plane is spanned by optical axes of the imaging beam bundle of the at least one optical imaging path, which impinge on the fourth mirror surface and exit the same, and the third plane is spanned by the optical axes of the imaging beam bundles of the at least one optical imaging path, which impinge on the second (or third) mirror surface and exit the same.

Here, the at least one optical imaging path between the second mirror surface and the third mirror surface may be free from optical lenses.

According to an embodiment, the at least one optical imaging path may also be deflected at more or less than four mirror surfaces, wherein the mirror surfaces may mutually enclose optional angles. A lateral reversal, distortion or rotation of the image, which then occurs, can then selectively be optically or digitally corrected by a corresponding correcting device.

According to an embodiment, the microscope system further comprises a second drive, which selectively pivots the second mirror surface about the second swivel axis. Additionally or alternatively, the microscope system may further comprise a first drive which selectively pivots the first mirror surface about the first swivel axis. Then, the controller is preferably adapted to control the first and/or second drive.

It may be advantageous if the first mirror surface is disposed between the object plane and a first optically active surface of the imaging system, which is disposed along the at least one optical imaging path. The reason is that in this case, the deflected optical imaging path need not pass e.g. through any optical lenses, which may possibly require large optical lenses in the case of a large tilting of the first mirror surface. Here, a surface with a radius of curvature of 10⁴ mm as a maximum and preferably 5*10³ mm as a maximum and especially preferably 10³ mm as a maximum is understood as an optically active surface. Thus, planar filters or covering panes which may be used in the inventive microscope system are to not be considered to be an optically active surface in the present case.

According to an embodiment, the optical imaging path between the first mirror surface and the object plane is free from optically active elements. Here, optically active elements are understood to be elements, the addition or removal of which results in a change of a working distance of the microscope system by more than 0.5% and especially by more than 1% and furthermore especially by more than 2% and furthermore especially by more than 5%. Filter or covering panes are not considered to be optically active elements in this connection.

The microscope system may, in general, be designed as a stereoscopic microscope system, in which the imaging system provides at least one pair of optical imaging paths which enclose a stereoscopic angle in the object plane. The imaging system may then comprise a first partial system which comprises a plurality of lenses which are disposed along a common optical axis and are commonly traversed by both optical imaging paths of the at least one pair of optical imaging paths.

Moreover, the first and/or the second mirror surface may be disposed along the optical axis of the first partial system between optical lenses of the first partial system. This arrangement of the mirror surfaces in the first partial system makes it easier, due to the use of comparatively large common optical lenses for all optical imaging paths, to ensure that the optical imaging paths are still threaded (directed) through the optical lenses even after a pivoting of the mirror surfaces.

Here, at least two lenses of the first partial system may be displaceable relative to each other along the optical axis, in order to e.g. commonly adjust a working distance and/or an magnification for all optical imaging paths of the microscope system.

Alternatively or additionally, the imaging system may in general comprise a second partial system whose optical elements comprise a plurality of lenses which are in each case traversed by only one optical imaging path of the at least one pair of optical imaging paths. Here, at least two lenses of the second partial system may be displaceable relative to each other along a common optical imaging path.

According to an embodiment, the microscope system may furthermore comprise an illumination system having an optical illumination path for the illumination of the object plane, the first and/or second mirror surface being disposed along the optical illumination path and the optical illumination path being deflected by at least the first and/or the second mirror surface.

Since the optical illumination path is also deflected by the first and/or second mirror surface, the optical illumination path is automatically tracked in the case of a pivoting of the mirror surface(s) for displacing the imaging field of the imaging system in the object plane. For this purpose, the optical illumination path is coupled into the at least one optical imaging path in a suitable fashion (e.g. by using a semi-transmitting mirror).

Alternatively, the microscope system may furthermore comprise an illumination system having an optical illumination path for illuminating the object plane, wherein at least one illumination mirror is disposed along the optical illumination path, which is pivotable in dependence on the displacement determined by the controller. As a result, it is ensured that the optical illumination path is automatically tracked in the case of a displacement of the imaging field of the imaging system due to a corresponding displacement of the at least one mirror surface by correspondingly pivoting the illumination mirror.

In order to also enable a rough positioning of the imaging field, in addition to the rapid and exact positioning of the imaging field by using the aforementioned displacement device, the microscope system may also comprise a stand which supports the imaging system and comprises at least one adjustment device for the translatory displacement of the imaging system as a whole. Here, the stand may e.g. comprise three or more translatory and two or more rotatory degrees of freedom in order to allow a positioning that is as flexible as possible.

A microscope system having the aforementioned properties can be preferably used as a surgical microscope.

### BRIEF DESCRIPTION OF THE DRAWINGS

Preferred embodiments of the present invention are described in the following with reference to the enclosed drawings. Inasmuch as this is possible the same or similar reference signs are used in the drawings in order to refer to the same or similar elements. Therein

FIG. 1A schematically shows an optical path through an arrangement of basic elements of an imaging system of a microscope system according to a preferred first embodiment of the present invention which arrangement is unfolded in one plane;

FIG. 1B schematically shows a top view from above on basic elements of the imaging system of FIG. 1A;

FIG. 1C schematically shows a lateral view of the basic elements of the imaging system of FIG. 1A;

FIG. 1D schematically shows a perspective view of a spatial arrangement of the basic elements of the imaging system of FIG. 1A;

FIG. 2 schematically shows an optical path through an arrangement of basic elements of an imaging system of a microscope system according to a second embodiment of the present invention which arrangement is unfolded in one plane;

FIG. 3 schematically shows an optical path through an arrangement of basic elements of an imaging system of a microscope system according to a third embodiment of the present invention;

FIG. 4A schematically shows a lateral view of a microscope system according to the second embodiment of the present invention; and

FIG. 4B schematically shows a lateral view of a microscope system according to a fourth embodiment of the present invention.

### DETAILED DESCRIPTION OF THE PREFERRED EMBODIMENT

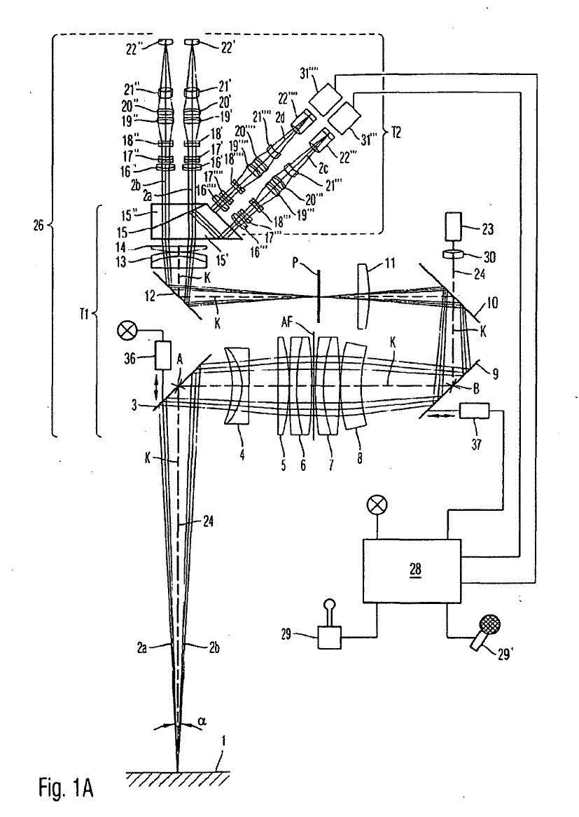

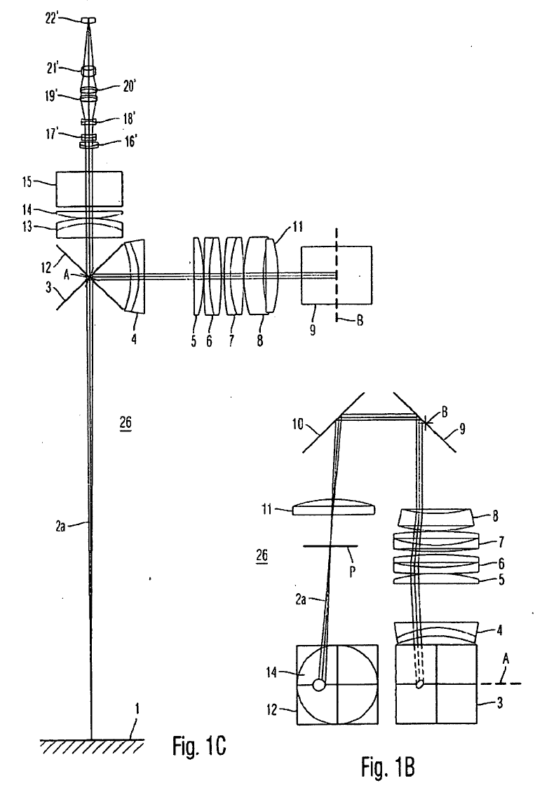

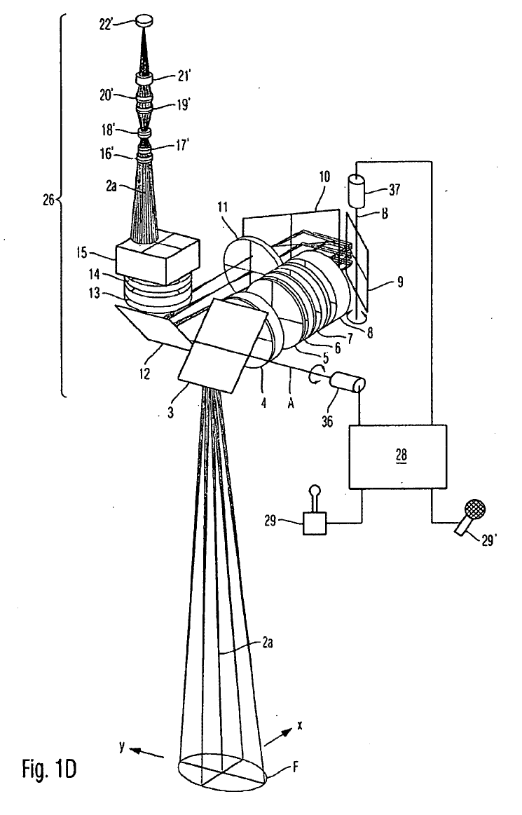

A first preferred embodiment of the present invention is explained in greater detail in the following with reference to FIGS. 1A, 1B, 1C and 1D.

FIG. 1A schematically shows an optical path through an arrangement of basic elements of an imaging system 26 of a microscope system according to the first embodiment of the present invention which arrangement is unfolded in one plane. Here, FIGS. 1B, 1C and 1D schematically show various views of basic elements of the imaging system of the microscope system according to the preferred embodiment. Additional elements of the microscope system are schematically shown in FIGS. 1A and 1D in the form of block diagrams.

The microscope system according to the first preferred embodiment comprises an optical imaging system 26 which provides two pairs of optical imaging paths 2a, 2b and 2c, 2d.

The optical imaging paths 2a and 2b as well as the optical imaging paths 2c and 2d coincide in each case pairwise in the object plane 1. Main beams of the optical imaging paths 2a, 2b and 2c, 2d enclose in each case pairwise a stereoscopic angle α. Thus, the microscope system forms a stereoscopic microscope. Here, the stereoscopic angle α enclosed in the object plane 1 by the first pair of optical imaging paths 2a, 2b may be different from the stereoscopic angle (not shown in the FIGS.) which is enclosed by the second pair of optical imaging paths 2c, 2d in the object plane 1. The stereoscopic angles which are pairwise enclosed by the optical imaging paths 2a, 2b and 2c, 2d in the object plane 1 may, however, be also of the same size. The stereoscopic angle α ranges from 4° to 6° in FIG. 1A. However, the present invention is not restricted to the aforementioned angular range. It is rather sufficient if the stereoscopic angle is unequal to zero degrees.

As shown in FIG. 1D, the optical imaging paths 2a, 2b, 2c and 2d are designed to pairwise image an imaging field F in the object plane 1. The imaging field F indicates the finite (i.e. not punctiform) area of an object (not shown) which is to be examined and is disposed in the object plane 1 and which area is imaged by the pairs of optical imaging paths 2a, 2b and 2c, 2d at a point in time (i.e. simultaneously). The size of the imaging field F depends on the size of the optical elements of the imaging system 26 and the magnification provided by the imaging system 26. In the example shown, the imaging field F has a diameter of from 10 mm to 100 mm. However, the present invention is not restricted to a specific size of the imaging field F. It is only essential that the pairs of optical imaging paths 2a, 2b and 2c, 2d are designed for imaging an area and not only a point in the object plane 1.

The imaging system 26 is formed by a first optical partial system T1 and a second optical partial system T2, said partial systems T1 and T2 having in each case a plurality of optical elements.

The first partial system T1 comprises along a common optical axis K a first optical deflection element having a first optical mirror surface 3, a first, second, third, fourth and fifth optical lens 4, 5, 6, 7 and 8, a second optical deflection element with a second optical mirror surface 9, a third optical deflection element with a third optical mirror surface 10, a sixth optical lens 11, a fourth optical deflection element with a fourth optical mirror surface 12, a seventh and eighth optical lens 13 and 14 and prism parts 15′, 15″ of a beam splitter arrangement 15.

The lenses 4, 5, 6, 7, 8, 11, 13 and 14 of the first partial system T1 are commonly traversed by the four optical imaging paths 2a, 2b, 2c and 2d. Moreover, an afocal interface AF is disposed between the third and the fourth optical lens 6, 7, in which the optical imaging paths 2a, 2b, 2c and 2d are in each case imaged towards infinite. The provision of the afocal interface AF renders a modular construction of the imaging system 26 possible. However, it is emphasized that the afocal interface AF is not required for implementing the invention.

The optical imaging paths 2a, 2b, 2c and 2d are successively reflected at the first mirror surface 3, the second mirror surface 9, the third mirror surface 10 and the fourth mirror surface 12 and thus deflected. As is especially well revealed by FIG. 1D, the normal vectors of the planes spanned by the first mirror surface 3 and the fourth mirror surface 12 relative to each other enclose a variable angle of from 70° to 110°. Moreover, normal vectors of the planes which are in each case spanned by the second mirror surface 9 and the third mirror surface 10 relative to each other enclose a variable angle of from 70° to 110°. However, the present invention is not restricted to such an angular range. Normal vectors of the planes which are spanned by the third mirror surface 10 and the fourth mirror surface 12 relative to each other enclose a constant angle of substantially 90°. Here, a deviation from 90° by 5° as a maximum and preferably by 2° as a maximum and especially preferred by 1° as a maximum is understood in this application by “substantially 90°”.

This arrangement of the first to fourth mirror surfaces 3, 9, 10 and 12 optically acts altogether as a Porro system of the second type. This means that the first to fourth mirror surfaces 3, 9, 10 and 12 cause both an image reversal and a pupil exchange. Moreover, an especially compact construction of the imaging system 26 is obtained by this arrangement of the mirror surfaces 3, 9, 10 and 12.

The first to fifth lenses 4, 5, 6, 7 and 8 are disposed between the first deflection element having the first mirror surface 3 and the second deflection element having the second mirror surface 9. The sixth lens 11 is disposed between the third deflection element with the third mirror surface 10 and the fourth deflection element with the fourth mirror surface 12. The seventh and the eighth lenses 13 and 14 are disposed between the fourth deflection element with the fourth mirror surface 12 and the beam splitter arrangement 15.

Thus, the optical path is free from optical lenses between the second deflection element with the second mirror surface 9 and the third deflection element with the third mirror surface 10. Moreover, the first mirror surface 3 is disposed between the object plane 1 and the first lens 4 and thus between the object plane 1 and the first optically active surface of the imaging system 26 along the optical imaging paths 2a, 2b, 2c and 2d. Here, a surface with a radius of curvature of 10⁴ mm as a maximum and preferably 5*10³ as a maximum and especially preferred 10³ mm as a maximum is understood be an optically active surface. Thus, e.g. planar filters or covering panes are not deemed as an optically active surface here. The present invention is, however, not restricted to such an arrangement of the first mirror surface. Thus, the first active surface of the imaging system may alternatively also disposed between the first mirror surface and the object plane (not shown).

The first deflection element comprising the first mirror surface 3 is pivotable about a first swivel axis A. To this end, the first deflection element is connected with a first drive 36. In the shown preferred embodiment the first drive 36 is a stepping motor whose motor axle directly forms the first swivel axis A, which supports the first deflection element having the first mirror surface 9. As can be best seen in FIG. 1D, a pivoting of the first mirror surface 3 about the first swivel axis A by using the first drive 37 results in a translatory displacement of the imaging field F of the imaging system 26 in the object plane 1 in the X-direction. Moreover, the first swivel axis A is located in an area in FIG. 1D, in which the optical axis K impinges on the first mirror surface 3. This is in the center of the first mirror surface 3 in FIG. 1D.

In a similar fashion the second deflection element having the second mirror surface 9 is pivotable about a second swivel axis B, said second swivel axis B being different from the first swivel axis A. For this purpose, the second deflection element is connected with a second drive 37, which, in the shown embodiment, is formed by a stepping motor, whose motor axle supports the second deflection element and determines the second swivel axis B. As can be seen from FIG. 1D, a pivoting of the second mirror surface 9 by using the second drive 38 results in a translatory displacement of the imaging field F of the imaging system 26 in the object plane 1 in the Y-direction. Moreover, the second swivel axis B is located in an area in FIG. 1D in which the optical axis K impinges on the second mirror surface 9. This is in the center of the second mirror surface 9 in FIG. 1D.

In the first preferred embodiment, the first swivel axis A encloses an angle of substantially 90° with a first deflection plane which is spanned by the optical axis K of the optical imaging paths 2a, 2b, 2c, 2d which impinges on the first mirror surface 3 and exits from the first mirror surface 3. Here, the optical axis K is defined by the lenses 4 to 8, 11, 13, 14 of the first partial system T1. It is obvious that the optical axis K does not extend along a single straight line in the first embodiment, but is bent by the mirror surfaces 3, 9, 10, 12. Moreover, the second swivel axis B also encloses an angle of substantially 90° with a second deflection plane which is spanned by the optical axis K of the optical imaging paths 2a, 2b, 2c, 2d which impinges on the second mirror surface 9 and exits from the second mirror surface 9. Here, main beams of the optical imaging paths 2a to 2d may also be used as a reference instead of the optical axis K. Obviously, the main beams of the optical imaging paths 2a, 2b, 2c and 2d must be in a common plane for this purpose. Moreover, the second swivel axis B is disposed substantially in parallel with the first deflection plane. This means that the second swivel axis B is in parallel with the first deflection plane or that the second swivel axis B intersects the first deflection plane and thereby encloses an angle of less than 5° and preferably less than 2° with the first deflection plane or that the second swivel axis B and the first deflection plane coincide. In the first embodiment shown the second swivel axis B is located in the first deflection plane. However, the present invention is not restricted to the above arrangement of the swivel axes.

Thus, the first and the second deflection element and the first and the second drive 36, 37 commonly form a displacement device in order to translatory displace the imaging field F of the imaging system 26 in the object plane 1 in an optional direction by using a combined driving of the first and the second drive 36, 37 and a corresponding pivoting of the first and the second mirror surface 3, 9. Here, limits are set to the displacement by the optics of the imaging system 26, since the optical imaging paths 2a, 2b, 2c, 2d must not be displaced to the outside of the optical lenses 4, 5, 6, 7, 8 of the imaging system 26, which are traversed by them.

The first and second drives 36, 37 are in each case connected with a controller 28. For the sake of a better clarity the connection line between the first drive 36 and the controller 28 is not completely shown in FIG. 1A. The controller 28 is connected with user interfaces in the form of a joystick 29 and a microphone 29′.

However, alternatively, optional other user interfaces may also be used which receive control commands from a user e.g. in the form of voice and/or a movement of the eye and/or a movement of the foot and/or a movement of the head and/or a movement of the hand of the user and output them to the controller (preferably in digital form or in analog form). Here, the control commands may e.g. indicate an absolute displacement and/or a relative displacement and/or only a direction of a displacement together with a period of time.

The controller 28 determines a desired displacement of the imaging field F in the object plane 1 and accordingly controls the first and second drives 36, 37 in dependence on a command by a user, which is received via the joystick 29 or the microphone 29′.

For determining an angular position of the first and the second mirror surface 3, 9 which angular position is required for a desired displacement of the imaging field F, the controller 28 can access a table in which the angular positions of the first and the second mirror surface 3, 9 which angular positions are required for a desired displacement, are stored in dependence on a respective total magnification of the microscope system. Alternatively or additionally, the controller may also use a corresponding conversion formula or control the first and the second drive 36, 37 directly in dependence on a received command by a user.

As already emphasized, the optical lenses 4-8 of the first partial system T1 are disposed along the common optical axis K. Here, the first lens 4 is displaceable relative to the second lens 5 and the third lens 6 is displaceable relative to the fourth lens 7 along the optical axis K in order to change a distance of the object plane 1 from the imaging system 26 of the microscope system and thus a working distance and/or a magnification of the image of an object which can be disposed in the object plane 1. At the same time, it is ensured by a suitable selection of system data of these optical lenses 4, 5, 6 and 7 that the optical imaging paths 2a and 2b as well as 2c and 2d pairwise enclose the stereoscopic angle D that differs from zero in the object plane even after a displacement of the lenses 4, 5, 6, 7.

The second partial system T2 of the imaging system 26 also comprises a plurality of optical elements 16′-22′, 16″-22″, 16′″-22′″ and 16″″-22″″, in which, as opposed to the first partial system T1, the optical imaging paths 2a, 2b, 2c and 2d are, however, separately guided in each case. This means that the optical lenses 16′-21′, 16″-21″, 16′″-21′″ and 16″″-21″″ are in each case traversed by one optical imaging path 2a, 2b, 2c or 2d each.

Each optical imaging path 2a and 2b of the second partial system T2 comprises a stereoscopic view, which is only schematically shown, formed by tube optics with the oculars 22′, 22″ for a direct visual observation by a user.

Each optical imaging path 2c and 2d of the second partial system T2 comprises a camera adapter 22′″ and 22″″ for a digital camera 31′″ and 31″″ for the generation of image data. Instead of separate cameras 31′″ and 31″″ a stereoscopic camera may also be used. The cameras 31′″ and 31″″ are each connected with the controller 28.

The controller 28 receives the image data generated in each case by the cameras 31′″, 31″″ and automatically detects the position of a marker (not shown) in the image data. Depending upon the application/viewed object, this marker may e.g. be a separate element that is specifically disposed in the object plane such as e.g. a characteristically designed adhesive label. Alternatively, the marker may e.g. also be a characteristic element of the object itself that is automatically identified in the image data such as a surgical element (or instrument) or a specific part of the body of a patient that is imaged in the image data.

In the embodiment shown the controller can be switched by using the joystick 29 and/or the microphone 29′ into an operating state in which the controller does not directly determine a desired displacement by using a command received via the joystick 29 and/or the microphone 29′, but indirectly by using the position of the marker which is detected in the image data. Subsequently, the controller 28 controls the first and second drives 36, 37 in dependence on the detected position of the marker. In this preferred embodiment the controller 28 controls the first and second drives 36, 37 such that the detected position of the marker remains substantially constant in the image data. This means that the controller pivots the first and second mirror surfaces 3, 9 by using the first and second drives 36, 37 such that a marker that is e.g. detected in the center of the image data remains in the center of the image data even after a displacement of the marker relative to the object plane. Here, it is to be understood by “substantially constant” that the relative position of the marker in the image data is not changed by more than 30% of a diameter of the imaging field F and preferably by more than 10% of the diameter of the imaging field F.

Moreover, three distances each between four lenses 16′-19′, 16″-19″, 16′″-19′″ and 16″″-19″″ which are disposed in a respective optical imaging path 2a, 2b, 2c and 2d along a common optical axis (not shown) are displaceable relative to each other in order to cause a change in a magnification of the image generated in each case by the second partial system T2 in the respective optical imaging paths 2a, 2b, 2c and 2d.

A physical beam splitter 15 is provided for the pairwise separation of the optical imaging paths 2a, 2b, 2c and 2d which comprises a partially transparent mirror surface which is traversed by a first pair of optical imaging paths 2a and 2b and at which a second pair of optical imaging paths 2c and 2d is reflected.

Moreover, the microscope system according to the first preferred embodiment provides a secondary optical path 24 which traverses the third mirror surface 10 of the third deflection element in a central area. This central area may preferably be located between cross-sectional beam surfaces of the optical imaging paths 2a, 2b, 2c and 2d. For this purpose, the third mirror surface 10 has a light transmittance for radiation of the secondary optical path 24 at least in sections, which is greater than a light transmittance for radiation of the optical imaging paths 2a, 2b, 2c, 2d. Alternatively, the coupling/integration of the secondary optical path 24 may, however, also be carried out in a different way.

In FIG. 1A the secondary optical path 24 is formed by illumination optics 30 of an illumination system, wherein the illumination system also comprises a radiation source 23. This illumination system is not part of the imaging system 26.

Alternatively, an infrared observation system (not shown) with infrared imaging optics and an infrared camera may be provided additionally to or instead of the illumination system comprising the illumination optics 30 and the radiation source 23, the infrared imaging optics providing the secondary optical path 24.

Moreover, a laser (not shown) with a beam guiding system (not shown) which provides the secondary optical path may also be provided additionally to or instead of the illumination system. Such a laser enables a therapeutical use, e.g. for the treatment of cancer.

Since the secondary optical path 24 is successively reflected and thus deflected by the second mirror surface 9 and the first mirror surface 3, the secondary optical path is automatically tracked in the case of a pivoting of the second mirror surface 9 and the first mirror surface 3 for the purpose of a translatory displacement of the imaging field F in the object plane 1. Thus, the microscope system shown in FIG. 1A comprises a 0° illumination for an object that can be disposed in the object plane 1 for each position of the mirror surfaces. The optical axis K of the first partial system T1 and the secondary optical path 24 overlap each other across wide areas in FIG. 1A.

In the aforementioned first preferred embodiment the first, second, third and fourth deflection elements are in each case an optical mirror. Alternatively, however, the deflection elements may e.g. also be prisms each with at least one mirror surface. Moreover, the first, second, third and fourth deflection elements each may optionally have several mirror surfaces for deflecting the optical imaging paths 2a, 2b, 2c and 2d. Moreover, more or less than two pairs of optical imaging paths may be provided.

In the aforementioned first preferred embodiment the first, second, third and fourth mirror surfaces are furthermore disposed such that the common optical axis K of the first partial system T1 is folded by the mirror surfaces such that it lies in at least one first and second plane which are substantially in parallel with each other and in at least one third plane which is substantially vertically to the two first and second planes. Here, the conditions of “substantially in parallel” and “substantially vertically” are considered to be fulfilled, if the third plane intersects the two first and second planes in each case at an angle of from 60° to 120° and preferably from 80° to 100° and especially preferred from 85° to 95° and in particular 90°. In the present case the first plane is spanned by the optical axis K incident on the first mirror surface 3 and exiting from the same, the second plane is spanned by the optical axis K incident on the fourth mirror surface 12 and exiting from the same and the third plane is spanned by the optical axis K incident on the second (or third) mirror surface 9 (or 10) and exiting from the same.

The microscope system according to the first preferred embodiment is especially well suited for use as a surgical microscope. The reason is that it is possible for a user to displace the imaging field F in the object plane 1 by pivoting the first and second mirror surfaces 3, 9 by using the controller 28 in an especially simple, rapid, reliable and vibration-free fashion. Moreover, the controller 28 may enable an automatic image stabilization and image tracking by automatically controlling the first and second mirror surfaces 3, 9 in dependence on the position of the marker which is detected in the image data.

For the sake of a better clarity only one optical imaging path 2a is shown in each case in FIGS. 1B to 1D. For the same reason, the optical imaging paths 2c and 2d are not completely shown in FIG. 1A. Moreover, a representation of the illumination system and the optical axis K of the first partial system T1 was omitted in FIGS. 1B, 1C and 1D. FIG. 1D schematically shows a perspective view in order to illustrate the actual spatial arrangement of basic elements of the imaging system 26 of the microscope system according to the first preferred embodiment (contrary to the arrangement unfolded in one plane in FIG. 1A).

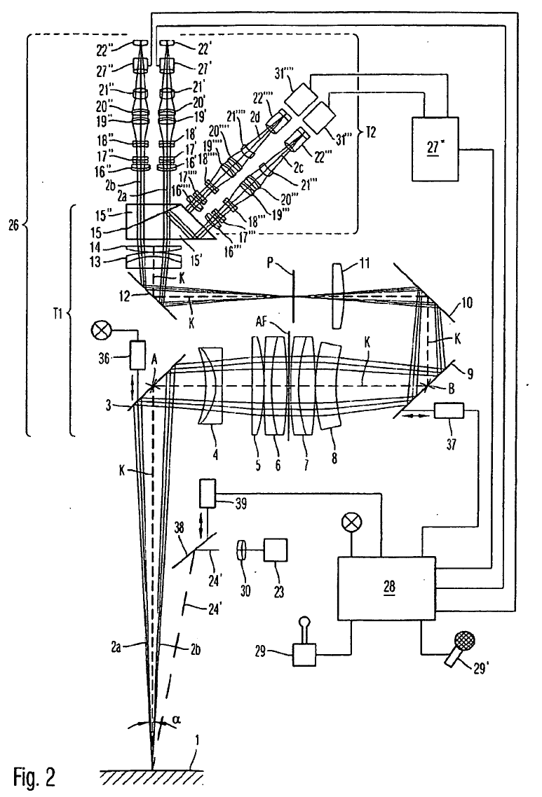

A second embodiment of a microscope system according to the present invention is described in the following with reference to FIG. 2. Here, FIG. 2 schematically shows an optical path through an arrangement of basic elements of an imaging system of the microscope system, which arrangement is unfolded in one plane. Additional elements of the microscope system are schematically represented in the form of block diagrams. Since the construction of the microscope system according to the second embodiment corresponds in many parts to the construction of the microscope system according to the first embodiment described above in detail, only differences between the first and the second embodiment will be explained.

By selectively pivoting the first and second mirror surfaces 3, 9, a rotation of the image of the object that can be arranged in the object plane 1 of the microscope system which is made by the imaging system 26, and thus of the imaging field F is caused, if the first and the second axis of rotation A, B of the first and second mirror surfaces 3, 9 do not enclose in each case an angle of substantially 90° with a respective deflection plane which is spanned by the optical axis K and/or the main beams of the optical imaging paths 2a to 2d of the first partial system T1 incident on the respective mirror surface 3, 9 and exiting from the respective mirror surface 3, 9.

In order to enable an arbitrary arrangement of the axes of rotation of the pivotable mirror surfaces 3, 9, the microscope system according to the second embodiment additionally comprises a compensation device which causes an (additional) rotation of the image of the imaging field F which is generated by the imaging system 26.

To this end, compensation device in the form of adjustable prism arrangements 27′ respectively 27″ are provided in each case in the first and the second optical imaging paths 2a, 2b. The adjustable prism arrangements 27′ and 27″ are connected with the controller 28 and comprise in each case at least one and preferably in each case at least two mirror surfaces, which can be rotated relative to each other for the optical rotation of the image provided by the imaging system 26. However, the present invention is not restricted to such a construction of the optical compensation device.

The controller 28 controls the adjustable prism arrangements 27′ and 27″ in dependence on a control of the first and second drives 36, 37 such that a rotation of the image of the object that is provided by the imaging system 26 caused by a pivoting of the first and second mirror surfaces 3, 9 is compensated by an opposite rotation of the image, which is caused by the adjustable prism arrangements 27′, 27″.

Moreover, the microscope system comprises a further compensation device in the form of an external graphics processor 27* for the compensation of a rotation of the image provided by the imaging system of the object in the optical imaging paths 2c and 2d. The graphics processor 27* is connected with the cameras 31′″ and 31″″ and with the controller 28. The controller 28 controls the graphics processor 27* in dependence on a control of the first and second drives 36, 37 such that a rotation of the image of the object provided by the imaging system 26 which rotation is caused by a pivoting of the first and second mirror surfaces 3, 9, is compensated by a rotation of the image with additional adaptation of the stereoscopic basis which rotation of the image is caused by the graphics processor 27* by using electronic image processing. Here, the controller 28 takes both the amount of the pivoting of the respective mirror surface 3, 9 and the orientation of the respective swivel axis A, B relative to the respectively deflected optical imaging path 2a, 2b, 2c and 2d respectively of the optical axis K of the first partial system T1 into consideration. Alternatively, the compensation can e.g. also be effected by the preferably controlled mechanical rotation of the pair of cameras 31′″, 31″″.

Moreover, the optical illumination path 24′ of the microscope system according to the second embodiment is not deflected by the pivotable first and second mirror surfaces 3, 9. In order to be nevertheless able to track the optical illumination path 24′ in the case of a displacement of the imaging field F in the object plane 1 due to a pivoting of the first and second mirror surfaces 3, 9, the microscope system comprises an additional illumination mirror 38. The illumination mirror 38 deflects the optical illumination path 24′ and, in the shown embodiment, it is pivotable by using a third drive 39 in the form of a stepping motor about two axes that are orthogonal to each other which are both located in a plane spanned by the illumination mirror 38. The two axes of the illumination mirror 38 intersect each other preferably in an area, in which the optical illumination path 24′ impinges on the illumination mirror 38. Here, the third drive 39 is connected with the controller 28. The controller 28 controls the third drive 39 in dependence on an activation of the first and second drives 36, 37 such that the illumination mirror 38 is pivoted, in the case of a pivoting of the first and second mirror surfaces 3, 9 for the purpose of displacing the imaging field F in the object plane 1, in such a way that the optical illumination path 24′ follows the displacement of the imaging field F.

In this second embodiment, as well, the optical illumination path 24′ may alternatively be any secondary optical path for observing and/or influencing an object that can be disposed in the object plane 1.

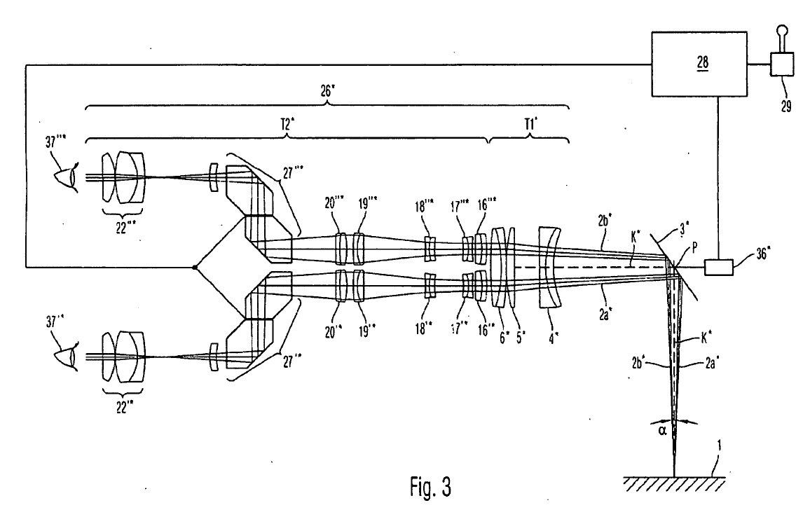

A third embodiment of a microscope system according to the present invention is described in the following with reference to FIG. 3. FIG. 3 schematically shows an optical path through basic elements of the microscope system, additional elements of the microscope system being schematically shown in the form of block diagrams.

The microscope system according to the third embodiment also comprises an imaging system 26* in order to image an object (not shown) disposed in an object plane 1. The imaging system 26*(as in the aforementioned first and second embodiments) is composed of a first partial system T1* with several optical lenses 4*, 5* and 6*, in which the optical imaging paths 2a*, 2b* are commonly guided, and a second partial system T2* with several optical lenses 16′*-20′*, 22′*, 16″*-20″*, 22″*, in which the optical imaging paths 2a*, 2b* are separately guided. Here, as well, the lenses of the first and the second partial system T1*, T2* are displaceable relative to each other for adjusting a working distance and/or for changing the image magnification. A more detailed description of these elements is dispensed with.

As opposed to the preceding embodiments, only two optical imaging paths 2a*, 2b* are provided, which enclose a stereoscopic angle α in the object plane and are supplied to the eyes 37′*, 37″* of a user via oculars 22′*, 22″*.

A separate mirror surface 3* is disposed along the optical imaging paths 2a*, 2b* between the imaging system 26* and the object plane 1* which separate mirror surface 3* is not part of the imaging system 26*. The area between the mirror surface 3* and the object plane 1* is thus free from optically active surfaces and/or elements.

The mirror surface 3* is connected with a drive 36* which drive 36* is adapted to selectively pivot the mirror surface 3* about a swivel point P in an optional direction. In the shown embodiment the swivel point P is located on an optical axis K of the first partial system T1* which optical axis K is defined by the optical lenses 4*, 5* and 6*. The swivel point P is located in the center of the mirror surface 3* in FIG. 3.

Moreover, the second partial system T2* of the imaging system 26* shown in FIG. 3 comprises a compensation device 27′*, 27″* in the form of an adjustable prism arrangement for each optical imaging path 2a*, 2b*.

Drives (not specifically shown) of the compensation device 27′*, 27″* and the drive 3* of the mirror surface 3* are connected with a controller 28 via data lines which, in turn, is connected via a data line with a user interface 29 (here represented in an example-like, but not restricting fashion, by a joystick).

The controller 28 activates the drive 36* in dependence on a command received via the user interface 29, in order to displace an imaging field (not shown in FIG. 3) of the imaging system 26* in the object plane 1 into an optional direction. At the same time, the controller 28 automatically controls the drives of the compensation device 27′*, 27″* such that the compensation device 27′*, 27″* automatically compensate a rotation of the image caused by a pivoting of the mirror surface 3*.

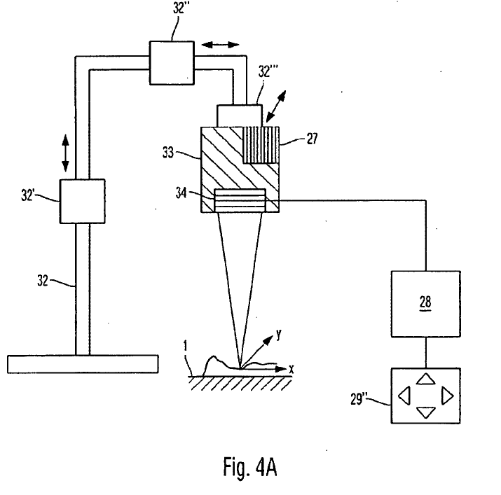

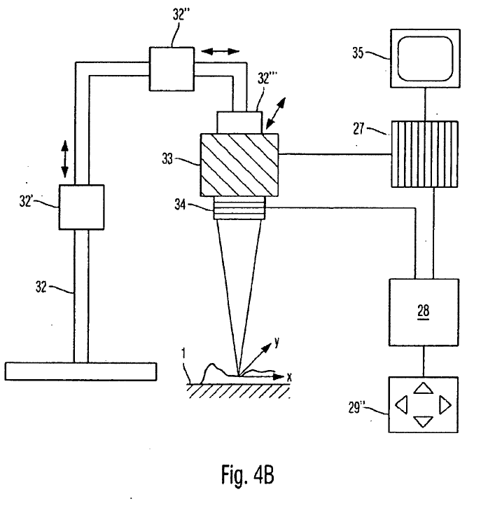

A lateral view of the construction of the microscope system according to the second embodiment of the present invention is schematically shown in FIG. 4A.

As shown, the microscope system can further comprise a stand 32 which supports a surgical microscope 33. The surgical microscope 33 comprises the imaging system 26, the compensation device 27 and the displacement device 34 in each case with the construction described in the second embodiment. The stand 32 enables a translatory and rotatory displacement of the surgical microscope 33 relative to the object plane 1 via drives 32′, 32″, 32′″.

In FIG. 4A the controller 28 comprises a keyboard 29″ for input of a desired displacement of the imaging field relative to the object plane.

A lateral view of a construction of a microscope system according to a fourth embodiment of the present invention is schematically shown in FIG. 4B.

Here, the fourth embodiment shown in FIG. 4B differs from the embodiment shown in FIG. 4A in particular in that the compensation device 27 and the displacement device 34 are not comprised by the surgical microscope 33, but are separate modules that can be connected with the surgical microscope 33. In FIG. 4B the compensation device 27 is formed by a graphics processor which outputs an image via a monitor 35 that is received by the surgical microscope 33 and rotated in dependence on the controller 28 and corrected with respect to its stereoscopic basis.

Even if one and/or two pivotable mirror surfaces are optionally provided in the aforementioned embodiments in order to displace an imaging field of the respective imaging system in the object plane, the present invention is not restricted to this. An optional number of pivotable mirror surfaces may rather be provided in order to displace the imaging field of the imaging system in the object plane. Moreover, the pivoting of the mirror surfaces may e.g. optionally be carried out by pivoting the respective mirror surface about more than one swivel axis or by rotating the respective mirror surface about an axis of rotation which encloses an angle that is different from zero with a normal to the mirror surface. This axis of rotation may coincide with an optical axis incident on the respective mirror surface. Due to such a rotation of the mirror surface, a pivoting of the mirror surface relative to the optical axis incident on the mirror surface is simultaneously caused, which results in a displacement of the imaging field in the object plane.

In summary, the present invention provides a microscope system which enables a displacement of an imaging field of an imaging system of a microscope system in an object plane in an especially simple, reliable and vibration-free fashion due to the pivoting of at least one mirror surface. As a result, it is possible in an especially convenient fashion by using the inventive microscope system to compensate for movements (and in particular also periodic movements) of an observed object by a corresponding displacement of the imaging field and to thus retain an observed object in the imaging field. The reason is that only a mirror surface must be pivoted and a displacement of the entire imaging system of the microscope system can thus be omitted. The displacement may be controlled by a controller which determines the desired displacement automatically or by using a user input. Moreover, a rotation of the image of an object made by the imaging system, which is possibly caused by a pivoting of the at least one mirror surface, can be automatically corrected by using a compensation device. To this end, the controller controls the compensation device in dependence on amount and direction of the pivoting of the at least one mirror surface.

Such a microscope system is especially suitable for use as a surgical microscope.

What is claimed is:

1. A microscope system for imaging an object disposable in an object plane of the microscope system, the microscope system comprising:
an imaging system which provides at least one optical imaging path for imaging an imaging field of the object plane;
a displacement device which is adapted to translatory displace the imaging field of the imaging system in the object plane; and
a controller which is adapted to determine a desired displacement of the imaging field in the object plane and to correspondingly control the displacement device;
wherein the displacement device comprises a first mirror surface disposed along the at least one optical imaging path for deflecting the at least one optical imaging path, said first mirror surface being pivotable in dependence on the displacement determined by the controller,
wherein the displacement device further comprises a second mirror surface disposed along the at least one optical imaging path for deflecting the at least one optical imaging path, said second mirror surface being pivotable in dependence on the displacement determined by the controller, and
wherein the first mirror surface is pivotable about a first swivel axis and the second mirror surface is pivotable about a second swivel axis, said second swivel axis being different from the first swivel axis.

2. The microscope system according to claim 1,
wherein the first swivel axis encloses an angle of substantially 90° with a first deflection plane which is spanned by an optical axis of the at least one optical imaging path, which optical axis impinges on the first mirror surface and exits from the first mirror surface, and
wherein the second swivel axis encloses an angle of substantially 90° with a second deflection plane which is spanned by the optical axis of the at least one optical imaging path, which optical axis impinges on the second mirror surface and exits from the second mirror surface and is disposed substantially in parallel with the first deflection plane.

3. The microscope system according to claim 1,
wherein the microscope system further comprises a compensation device which causes a rotation of the image of the imaging field generated by the imaging system, and
wherein the controller controls the compensation device in dependence on a pivoting of at least one of the first and the second mirror surface.

4. The microscope system according to claim 3,
wherein the imaging system comprises at least one camera disposed in the at least one optical imaging path for generation of image data; and
wherein the compensation device is connected with the at least one camera and causes a rotation of image data generated by the at least one camera by using the electronic image processing.

5. The microscope system according to claim 3, wherein the compensation device comprises at least one prism arrangement which is disposed in the at least one optical imaging path and is adjustable by the controller.

6. A microscope system for imaging an object disposable in an object plane of the microscope system, wherein the microscope system comprises:
an imaging system which provides at least one optical imaging path for imaging an imaging field of the object plane; and
a displacement device which is adapted to translatory displace the imaging field of the imaging system in the object plane;
wherein the displacement device comprises at least one pair of first and second mirror surfaces disposed along the at least one optical imaging path for deflecting the at least one optical imaging path, wherein the at least one pair of optical imaging paths is successively reflected at the first and the second mirror surface;
wherein the first mirror surface is pivotable about a first swivel axis, said first swivel axis enclosing an angle of substantially 90° with a first deflection plane which is spanned by an optical axis of the at least one optical imaging path, which impinges on the first mirror surface and exits from the first mirror surface; and
wherein the second mirror surface is pivotable about a second swivel axis, said second swivel axis enclosing an angle of substantially 90° with the second deflection plane which is spanned by the optical axis of the at least one optical imaging path, which impinges on the second mirror surface and exits from the second mirror surface, and which second swivel axis is disposed substantially in parallel with the first deflection plane.

7. The microscope system according to claim 6, wherein the microscope system further comprises a controller which is adapted to determine a desired displacement of the imaging field in the object plane and to pivot the first and second mirror surfaces in dependence on the determined displacement about at least one of the respective first and second swivel axis.

8. The microscope system according to claim 1, wherein the imaging system comprises at least one camera disposed in the at least one optical imaging path for generating image data; and
wherein the controller is connected with the at least one camera and is further adapted to detect the position of a marker in the image data and to control the displacement device in dependence on the detected position of the marker.

9. The microscope system according to claim 8, wherein the controller automatically controls the displacement device in such a way that the position of the marker in the image data remains substantially constant.

10. The microscope system according to claim 1, wherein the controller comprises a user interface and determines the desired displacement of the imaging field in the object plane in dependence on a control command received via the user interface.

11. The microscope system according to claim 10, wherein the user interface is adapted to receive control commands by a user in the form of at least one of voice and a movement of the eye and a movement of the foot and a movement of the head and a movement of the hand of the user and to output it to the controller.

12. The microscope system according to claim 1,
wherein the imaging system comprises a plurality of optical lenses; and
wherein at least one optical lens of the imaging system is disposed between the first and the second mirror surface.

13. The microscope system according to claim 1,
wherein the imaging system comprises a third mirror surface and a fourth mirror surface for deflecting the at least one optical imaging path; and
wherein the at least one optical imaging path is successively reflected at the first mirror surface, the second mirror surface, the third mirror surface and the fourth mirror surface.

14. The microscope system according to claim 13, wherein the first mirror surface and the fourth mirror surface enclose relative to each other an angle of from 60° to 120° and preferably of from 80° to 100°, and the second mirror surface and the third mirror surface enclose relative to each other an angle of from 60° to 120° and preferably from 80° to 100°.

15. The microscope system according to claim 14, wherein the third mirror surface and the fourth mirror surface enclose relative to each other an angle of substantially 90°.

16. The microscope system according to claim 13, wherein the at least one optical imaging path between the second mirror surface and the third mirror surface is free from optical lenses.

17. The microscope system according to claim 1, wherein the microscope system further comprises a second drive, which selectively pivots the second mirror surface about the second swivel axis.

18. The microscope system according to claim 17, wherein the microscope system further comprises a first drive which selectively pivots the first mirror surface about the first swivel axis.

19. The microscope system according to claim 18, wherein the controller controls at least one of the first and second drive.

20. The microscope system according to claim 1, wherein the first mirror surface is disposed between the object plane and a first optically active surface of the imaging system, which is disposed along the at least one optical imaging path.

21. The microscope system according to claim 1, wherein the imaging system provides at least one pair of optical imaging paths which enclose a stereoscopic angle in the object plane; and
wherein the imaging system comprises a first partial system which comprises a plurality of lenses which are disposed along a common optical axis and are traversed by both of the two optical imaging paths of the at least one pair of optical imaging paths.

22. The microscope system according to claim 21, wherein at least one of the first and second mirror surface is disposed along the optical axis of the first partial system between optical lenses of the first partial system.

23. The microscope system according to claim 21, wherein at least two lenses of the first partial system are displaceable along the optical axis relative to each other.

24. The microscope system according to claim 1, wherein the imaging system comprises a second partial system, whose optical elements comprise a plurality of lenses, which are each traversed by only one optical imaging path of the at least one pair of optical imaging paths.

25. The microscope system according to claim 24, wherein at least two lenses of the second partial system are displaceable relative to each other along a common optical imaging path.

26. The microscope system according to claim 1,
wherein the microscope system further comprises an illumination system having an optical illumination path for the illumination of the object plane;
wherein at least one of the first and second mirror surface is disposed along the optical illumination path; and
wherein the optical illumination path is deflected at least by at least one of the first and second mirror surface.

27. The microscope system according to claim 1,
wherein the microscope system further comprises an illumination system having an optical illumination path for the illumination of the object plane; and
wherein at least one illumination mirror is disposed along the optical illumination path, which illumination mirror is pivotable in dependence on the displacement determined by the controller.

28. The microscope system according to claim 1, wherein the microscope system further comprises a stand which supports the imaging system and comprises at least one displacement device for the translatory displacement of the imaging system.

29. The microscope system according to claim 1, wherein the microscope system is a surgical microscope.

30. A microscope system for imaging an object disposable in an object plane of the microscope system, the microscope system comprising:
an imaging system which provides at least one optical imaging path for imaging an imaging field of the object plane;
a displacement device which is adapted to translatory displace the imaging field of the imaging system in the object plane; and
a controller which is adapted to determine a desired displacement of the imaging field in the object plane and to correspondingly control the displacement device;
wherein the displacement device comprises a first mirror surface disposed along the at least one optical imaging path for deflecting the at least one optical imaging path, said first mirror surface being pivotable in dependence on the displacement determined by the controller.

31. The microscope system according to claim 30,
wherein the imaging system comprises a second mirror surface, a third mirror surface and a fourth mirror surface for deflecting the at least one optical imaging path; and
wherein the at least one optical imaging path is successively reflected at the first mirror surface, the second mirror surface, the third mirror surface and the fourth mirror surface.

32. The microscope system according to claim 31, wherein the first mirror surface and the fourth mirror surface enclose relative to each other an angle of from 60° to 120° and preferably of from 80° to 100°, and the second mirror surface and the third mirror surface enclose relative to each other an angle of 90°, and the third mirror surface and the fourth mirror surface enclose relative to each other an angle of substantially 90°.

33. The microscope system according to claim 30,
wherein the microscope system further comprises an illumination system having an optical illumination path for the illumination of the object plane;
wherein the first mirror surface is disposed along the optical illumination path; and
wherein the optical illumination path is deflected at least by the first mirror surface.

34. The microscope system according to claim 30,
wherein the microscope system further comprises an illumination system having an optical illumination path for the illumination of the object plane; and
wherein at least one illumination mirror is disposed along the optical illumination path, which illumination mirror is pivotable in dependence on the displacement determined by the controller.

35. The microscope system according to claim 30,
wherein the microscope system further comprises a compensation device which causes a rotation of the image of the imaging field generated by the imaging system;
wherein the controller controls the compensation device in dependence on a pivoting of the first mirror surface;
wherein the imaging system comprises at least one camera disposed in the at least one optical imaging path for generation of image data; and
wherein the compensation device is connected with the at least one camera and causes a rotation of image data generated by the at least one camera by using the electronic image processing.

36. The microscope system according to claim 30, wherein the imaging system comprises at least one camera disposed in the at least one optical imaging path for generating image data; and
wherein the controller is connected with the at least one camera and is further adapted to detect the position of a marker in the image data and to control the displacement device in dependence on the detected position of the marker,
wherein the controller automatically controls the displacement device in such a way that the position of the marker in the image data remains substantially constant.

37. The microscope system according to claim 30, wherein the first mirror surface is disposed between the object plane and a first optically active surface of the imaging system, which is disposed along the at least one optical imaging path.
